(19) United States
(12) Patent Application Publication
(10) Pub. No.: US 2015/0206621 A1
(43) Pub. Date: Jul. 23, 2015

(54) Electrical Insulator Comprising An Organofluorine Compound And Method For Producing It

(71) Applicants: Navid Mahdizadeh, Baden (CH); Patrick Stoller, Zürich (CH); Denis Tehlar, Zürich (CH); Anna Di Gianni, Dättwil (CH)

(72) Inventors: Navid Mahdizadeh, Baden (CH); Patrick Stoller, Zürich (CH); Denis Tehlar, Zürich (CH); Anna Di Gianni, Dättwil (CH)

(21) Appl. No.: 14/676,267

(22) Filed: Apr. 1, 2015

Related U.S. Application Data
(63) Continuation of application No. PCT/EP2013/070401, filed on Oct. 1, 2013.
Application No. PCT/EP2013/070401 is a continuation of application No. PCT/EP2010/069381, filed on Oct. 1, 2012.

(51) Int. Cl. H01B 3/40; B29C 45/73; H01B 17/56; B29C 45/00

(52) U.S. Cl. CPC H01B 3/40; B29C 45/0001; B29C 45/73; H01B 17/56; B29L 2031/3412

(57) ABSTRACT

An electrical insulator for an electrical apparatus, the insulator including a body containing an electrical insulating solid material and non-solid inclusions dispersed within the body. At least a portion of the inclusions include at least one organofluorine compound having a lower Global Warming Potential than SF₆.

### FIELD OF THE INVENTION

The present invention relates to an electrical insulator as well as to a method for preparing the electrical insulator according to the preamble of the independent claims 1 and 20. The present invention further relates to an apparatus for the generation, the distribution and/or the usage of electrical energy, said apparatus comprising the electrical insulator, and to the use of the electrical insulator as a high-voltage insulator as well as to the use in an insulating spacer, a post type spacer, a partition insulator or base insulator, a support insulator, a suspended insulator, a bushing, a high voltage insulator, a medium voltage insulator, a low voltage insulator, a cast insulating cylinder, an insulating envelope, an insulating rod, an insulating shaft, an insulating joint, an insulating terminal, a cable insulation, and/or an insulating coating. Still further, the present invention relates to the use of an organofluorine compound as a cover gas in the processing of a prepolymeric or polymeric mass, in particular for providing an electrical insulating, solid material for an electrical insulator.

### BACKGROUND OF THE INVENTION

Electrical insulators are well known in the art. They are used in electrical equipment to support and separate electrical conductors without allowing current flow through the insulator itself. In particular when used for high-voltage applications, the electrical insulator can be subject to partial discharge phenomena. Partial discharge is a localised dielectric breakdown of a small portion of the electrical insulation system under high voltage stress.

In a solid electrical insulator, partial discharge often starts within voids or cracks formed within the body of the insulator. Because the dielectric constant of the gas contained in the void is normally considerably less than that of the surrounding solid material, the electric field in the void is significantly higher than in the solid material. If the voltage stress across the void is increased above the corona inception voltage of the gas contained therein, partial discharge will then occur. In commercial production, the casting process is made in atmospheric air and voids are filled with air, which leads to poorer dielectric strength compared to the dielectric strength of the surrounding solid insulating material.

Protracted partial discharge can erode solid insulation and eventually lead to breakdown of the insulation. In order to prevent this, attempts to eliminate the formation of voids within the insulating material and, thus, to suppress initiation of partial discharge have been made.

With regard to insulating materials based on epoxy resin, for example, a so-called “vacuum casting” has been proposed with the aim of eliminating voids or any other defects in them. A corresponding method is e.g. referred to on the website http://www.toshiba.co.jp/sis/en/tands/insulator/index.htm.

Methods for eliminating voids in a polymeric material such as an epoxy resin are, however, relatively complex and require sophisticated facilities. This is particularly the case for a large scale production, since thereby relatively large reactor spaces need to be evacuated.

In consideration of this drawback, the object of the present invention is to provide an electrical insulator which is easy to manufacture and which at the same time shows a very low tendency for partial discharge.

### SUMMARY OF THE INVENTION

The object of the present invention is solved by the subject matter of the independent claims. Preferred embodiments are defined in the dependent claims.

Specifically, the present invention relates to an electrical insulator for an electrical apparatus, such as a transformer or switchgear, said insulator comprising a body containing an electrical insulating, solid material and non-solid inclusions dispersed within the body. The electrical insulator of the present invention is characterized in that at least a portion of the inclusions comprise at least one organofluorine compound having a lower Global Warming Potential than SF₆.

Thus, the body of the electrical insulator comprises a plurality of gaseous and/or liquid inclusions. Each inclusion defines a separate inclusion space, i.e. a cavity or void, surrounded by the electrical insulating, solid material. As mentioned, the inclusions can be formed of a gas or liquid or both; accordingly, the inclusion spaces can independently from each other contain a gas, a liquid or both.

Due to at least a portion of the inclusions containing an organofluorine compound, the present invention allows for providing a very high dielectric strength within the inclusion space. Compared to conventional electrical insulators comprising air inclusions, the tendency of the electrical insulator for partial discharge is thus significantly reduced. Ultimately, this results in a much safer operation of the electrical apparatus compared with an apparatus provided with a conventional insulator comprising air inclusions.

The approach of the present invention is thus completely different to the one proposed by the state of the art mentioned above which teaches voids to be eliminated. Rather, the present invention allows these voids to be present, but renders them less harmful by “filling” them with an organofluorine compound having a high dielectric strength. In embodiments, the inclusions have a dielectric strength higher than that of air, and/or the organofluorine compound has a dielectric strength higher than that of air.

In embodiments, the inclusions comprise at least one component selected from the group consisting of: air, air component, carbon dioxide (CO₂), oxygen (O₂), nitrogen (N₂), noble gas, nitric oxide, nitrogen dioxide, and mixtures thereof.

According to the present invention, the organofluorine compound has a lower Global Warming Potential (GWP) than SF₆. In embodiments, the inclusions in the electrical insulator have a global warming potential GWP over 100 years of less than 22'800, preferably less than 15'000, more preferably less than 10'000, even more preferably less than 5'000, even more preferably less than 3'000, even more preferably less than 2'000.

The GWP is a relative measure of how much heat a greenhouse gas traps in the atmosphere. It compares the amount of heat trapped by a certain mass of the gas in question to the amount of heat trapped by a similar mass of carbon dioxide. A GWP is calculated over a specific time interval, commonly 20, 100 or 500 years. It is expressed as a factor of carbon dioxide (CO₂), whose GWP is standardized to 1. Further, the organofluorine compound used according to the present invention is generally non-toxic or has a very low toxicity level, as discussed below.

Given the fact that the organofluorine compound has a GWP lower than SF₆, the electrical insulator of the present invention and, more particularly, the method for producing it has no substantial impact on the environment. There is, thus, no need for intricate safety measures that would be required, when SF₆ is employed.

In a specific embodiment of the present invention, the organofluorine compound has a global warming potential GWP over 100 years of less than 1000, preferably less than 700, more preferably less than 300, further more preferably less than 100, further more preferably less than 50, further more preferably less than 20, most preferred less than 10.

Regarding the environmental aspect, the organofluorine compound according to the present invention generally has an Ozone Depletion Potential (ODP) of 0.

In the context of the present invention, the term “inclusion” is to be interpreted broadly and encompasses any non-solid material surrounded by the electrical insulating, solid material. Likewise, the terms “inclusion space” is to be interpreted broadly and encompasses any separate space formed within the electrical insulating, solid material or at the interface or boundary between two different materials. In particular, it encompasses a void, which in the following is also referred to as bubble. More particularly, the term “inclusion space” encompasses bubbles which are spontaneously formed within a prepolymeric or a polymeric mass during its processing. More particularly, the term encompasses bubbles in the submillimeter scale, i.e. having an average diameter of less than 1 millimeter, and more particularly bubbles in the microscopic scale, i.e. bubbles which are smaller than those that can easily be seen by the naked eye and which require a lens or microscope to see them clearly.

Specifically, the term “inclusion space” or “inclusion” or “bubble” also encompasses the interior of hollow bodies, e.g. microspheres, used for reducing the density of the electrical insulating solid material and in particular of a polymeric material of the electrical insulating solid material.

Although an inclusion can contain both gaseous and/or liquid components and in particular can be a two-phase system, the inclusions of the present invention generally or in embodiments are gas inclusions, meaning that every component of the inclusions is in gaseous form at operational conditions of the electrical apparatus.

Furthermore, the inclusions, and in particular the gas inclusions, can independently from each other comprise one single component or a mixture of components; accordingly, the inclusion spaces can independently from each other contain one single component or a mixture of components.

In particular, the inclusions can comprise air and/or at least one air component, in particular selected from the group consisting of carbon dioxide (CO₂), oxygen (O₂) and nitrogen (N₂), and/or a noble gas, and/or nitric oxide, and/or nitrogen dioxide. According to a particularly preferred embodiment, the inclusions comprising the at least one organofluorine compound further comprise O₂, since this allows the formation of harmful decomposition products to be efficiently avoided.

As mentioned, the inclusions of the electrical insulator according to the present invention generally are gas inclusions. It is thus particularly preferred that the at least one organofluorine compound is in the gaseous state at operational conditions of the electrical apparatus. Specifically, the at least one organofluorine compound can be in the gaseous state over the whole temperature range to which the electrical insulator is typically exposed; it, thus, has a boiling point higher than the lowest temperature of exposure. More preferably, every component of the inclusions is in the gaseous state at operational conditions of the electrical apparatus. Since there is no phase transition of the organofluorine compound occurring, and in particular no vaporisation, the insulator is not subject to any stress that might occur when there is a significant pressure increase in the inclusion spaces and that can ultimately lead to the formation of cracks. Thus, the organofluorine compound being in the gaseous state at operational conditions of the electrical apparatus further contributes to the high stability and breakdown resistance of the insulator.

As mentioned herein, the present invention encompasses both embodiments, in which at least a portion of the inclusions, more particularly the gas inclusions, comprise further components apart from the organofluorine compound, as well as embodiments in which at least a portion of the inclusions, more particularly the gas inclusions, essentially consists of the organofluorine compound.

Embodiments of the method relate to performing the processing in the presence of a cover gas comprising the at least one organofluorine compound.

In embodiments, the processing of the prepolymeric or polymeric mass comprises the method elements of: (i) forming voids, which comprise the organofluorine compound, in the prepolymeric or polymeric mass, and (ii) stabilizing the voids such that an amount of the organofluorine compound is comprised in the voids and forms inclusions of the electrical insulator.

In general, the electrical insulating, solid material is a polymeric material. According to a more particular embodiment, the polymeric material is selected from the group of silicones, acrylic resins, polystyrenes, polyurethanes, polyimides, polyamides, polyesters, polyolefins, polyethers, polyketones, polysulfones and epoxy polymers, as well as mixtures thereof. Particularly preferred are silicones, acrylic resins, polystyrenes, polyurethanes, polyesters and/or epoxy polymers. Since these materials can be prone to oxidative degradation when air inclusions are contained, the presence of an organofluorine compound having a low oxidation potential is of particular interest in these embodiments.

As mentioned, the processing of a polymeric or prepolymeric material typically goes along with the formation of bubbles. As will be pointed out in the context of the method, this spontaneous bubble formation allows preparing the electrical insulator in a very straightforward manner by simply performing the processing in the presence of the organofluorine compound, thereby “filling” the bubbles with the organofluorine compound.

Thus, in specific embodiments of the present invention, at least some of the inclusions each define a separate bubble, the size of which being in the submillimeter scale, more particularly in the microscopic scale. For example, said bubble has an average diameter in the range from 10 μm (micrometer) to 500 μm, preferably from 50 μm to 300 μm, more preferably from 100 μm to 200 μm. Of course, bubbles having a larger diameter, in particular of up to 2 mm, can also be present.

According to an embodiment, the body of the electrical insulator has a density higher than 120 kg/m³, preferably higher than 150 kg/m³, more preferably higher than 170 kg/m³, and most preferably higher than 220 kg/m³. According to this embodiment, the density is thus higher than e.g. the one of an insulating foam to be used in a cable, particularly of the low loss foam disclosed in US 2004/0220287.

According to a further embodiment, the at least one organofluorine compound is selected from the group consisting of fluoroethers, in particular hydrofluoromonoethers, fluoroketones and fluoroolefins, in particular hydrofluoroolefins, and mixtures thereof. These classes of compounds have been found to have very high insulation capabilities, in particular a high dielectric strength (or breakdown field strength), and at the same time a low GWP.

The invention encompasses both embodiments in which the organofluorine compound comprises either one of a fluoroether, in particular a hydrofluoromonoether, a fluoroketone and a fluoroolefin, in particular a hydrofluoroolefin, as well as embodiments in which the organofluorine compound comprises a mixture of at least two of these compounds.

The term “fluoroether” as used in the context of the present invention encompasses both perfluoroethers, i.e. fully fluorinated ethers, and hydrofluoroethers, i.e. ethers that are only partially fluorinated. The term further encompasses saturated compounds as well as unsaturated compounds, i.e. compounds including double and/or triple bonds. The at least partially fluorinated alkyl chains attached to the oxygen atom of the fluoroether can be linear or branched.

The term “fluoroethers” encompasses both non-cyclic and cyclic ethers. Thus, the two alkyl chains attached to the oxygen atom can optionally form a ring. In particular, the term encompasses fluorooxiranes. In a specific embodiment, the organofluorine compound according to the present invention is a perfluorooxirane or a hydrofluorooxirane, more specifically a perfluorooxirane or hydrofluorooxirane comprising from three to fifteen carbon atoms.

According to a particularly preferred embodiment, at least a portion of the inclusions comprises a hydrofluoromonoether containing at least three carbon atoms.

Apart from their high dielectric strength, these hydrofluoromonoethers are chemically and thermally stable to temperatures above 140° C. They are further non-toxic or have a low toxicity level. In addition, they are non-corrosive and non-explosive.

The term “hydrofluoromonoether” as used herein refers to a compound having one and only one ether group, said ether group linking two alkyl groups, which can be, independently from each other, linear or branched, and which can optionally form a ring. The compound is thus in clear contrast to the compounds disclosed in, e.g., U.S. Pat. No. B-7,128,133, relating to the use of compounds containing two ether groups, i.e. hydrofluorodiethers, in heat-transfer fluids.

The term “hydrofluoromonoether” as used herein is further to be understood such that the monoether is partially hydrogenated and partially fluorinated. It is further to be understood such that it may comprise a mixture of differently structured hydrofluoromonoethers. The term “structurally different” shall broadly encompass any difference in sum formula or structural formula of the hydrofluoromonoether.

As mentioned above, hydrofluoromonoethers containing at least three carbon atoms have been found to have a relatively high dielectric strength. Specifically, the ratio of the dielectric strength of the hydrofluoromonoethers according to the present invention to the dielectric strength of SF₆ is greater than about 0.4.

As also mentioned, the GWP of the hydrofluoromonoethers is low. Preferably, the GWP is less than 1'000 over 100 years, more specifically less than 700 over 100 years.

The hydrofluoromonoethers mentioned have a relatively low atmospheric lifetime and in addition are devoid of halogen atoms that play a role in the ozone destruction catalytic cycle, namely Cl, Br or I. Their ODP is zero, which is very favourable from an environmental perspective.

The preference for a hydrofluoromonoether containing at least three carbon atoms and thus having a relatively high boiling point of more than −20° C. is based on the finding that a higher boiling point of the hydrofluoromonoether generally goes along with a higher dielectric strength.

According to a particular embodiment, the hydrofluoromonoether contains exactly three or four or five or six carbon atoms, in particular exactly three or four carbon atoms, most preferably exactly three carbon atoms.

More particularly, the hydrofluoromonoether is thus at least one compound selected from the group consisting of the compounds defined by the following structural formulae in which a part of the hydrogen atoms is substituted by a fluorine atom:

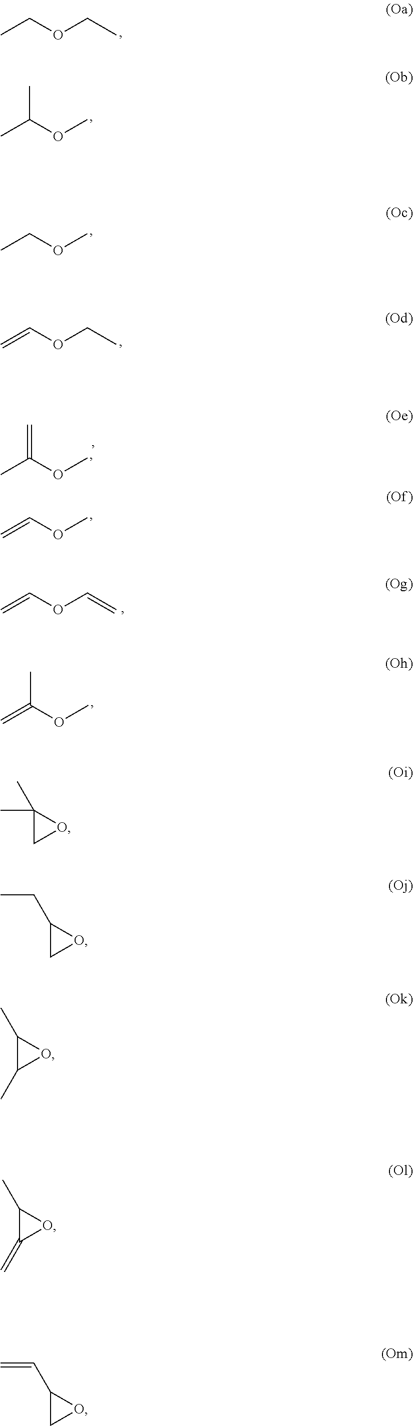

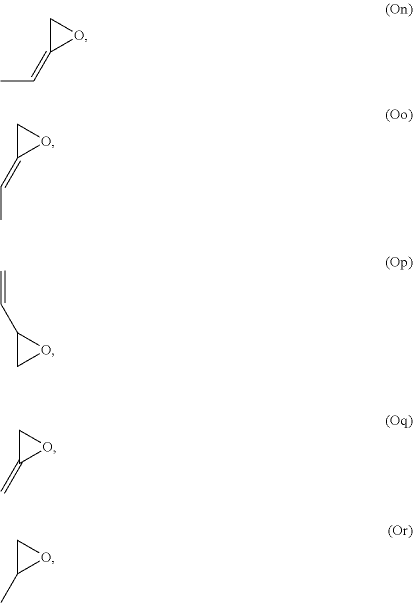

By using a hydrofluoromonoether containing three or four carbon atoms, no liquefaction occurs under typical operational conditions. Thus, inclusions in which every component is in the gaseous state at operational conditions of the electrical apparatus can be achieved, which is advantageous, as mentioned above.

Considering flammability of the compounds, there are further embodiments in which the ratio of the number of fluorine atoms to the total number of fluorine and hydrogen atoms, here briefly called “F-rate”, of the hydrofluoromonoether is at least 5:8. It has been found that compounds falling within this definition are generally non-flammable and thus result in an insulation medium complying with highest safety requirements. Thus, safety requirements of the electrical insulator and the method of its production can readily be fulfilled by using a corresponding hydrofluoromonoether.

According to other embodiments, the ratio of the number of fluorine atoms to the number of carbon atoms, here briefly called “F/C-ratio”, can range from 1.5:1 to 2:1. Such compounds generally have a GWP of less than 1'000 over 100 years, and are thus very environment-friendly. In particular, the hydrofluoromonoether can have a GWP of less than 700 over 100 years.

According to other embodiments of the present invention, at least a portion of the inclusions comprises a hydrofluoromonoether having the general structure (O)

CₐH_{b}F_{c}—O—C_{d}HₑF_{f} (O)

wherein a and d independently are an integer from 1 to 3 with a+d=3 or 4 or 5 or 6, in particular 3 or 4, b and c independently are an integer from 0 to 11, in particular 0 to 7, with b+c=2a+1, and e and f independently are an integer from 0 to 11, in particular 0 to 7, with e+f=2d+1, with further at least one of b and e being 1 or greater and at least one of c and f being 1 or greater.

It is thereby a further embodiment that in the general structure or formula (0) of the hydrofluoromonoether:

a is 1, b and c independently are an integer ranging from 0 to 3 with b+c=3, d=2, e and f independently are an integer ranging from 0 to 5 with e+f=5, with further at least one of b and e being 1 or greater and at least one of c and f being 1 or greater.

According to a further embodiment, exactly one of c and f in the general structure (0) is 0. The corresponding grouping of fluorines on one side of the ether linkage, with the other side remaining unsubstituted, is called “segregation”. Segregation has been found to reduce the boiling point compared to unsegregated compounds of the same chain length. This feature is thus of particular interest, because compounds with longer chain lengths allowing for higher dielectric strength can be used without risk of liquefaction under operational conditions.

In embodiments, the hydrofluoromonoether is selected from the group consisting of pentafluoro-ethyl-methyl ether (CH₃—O—CF₂CF₃) and 2,2,2-trifluoroethyl-trifluoromethyl ether (CF₃—O—CH₂CF₃).

Pentafluoro-ethyl-methyl ether has a boiling point of +5.25° C. and a GWP of 697 over 100 years, the F-rate being 0.625; while 2,2,2-trifluoroethyl-trifluoromethyl ether has a boiling point of +11° C. and a GWP of 487 over 100 years, the F-rate being 0.75. They both have an ODP of 0 and are thus environmentally fully acceptable.

In addition, pentafluoro-ethyl-methyl ether has been found to be thermally stable at a temperature of 175° C. for 30 days and therefore to be fully suitable for the operational conditions given in an electrical insulator. Since thermal stability studies of hydrofluoromonoethers of higher molecular weight have shown that the stability of ethers containing fully hydrogenated methyl or ethyl groups have a lower thermal stability compared to those having partially hydrogenated groups, it can be assumed that the thermal stability of 2,2,2-trifluoroethyl-trifluoromethyl ether is even higher.

Hydrofluoromonoethers in general, and pentafluoro-ethyl-methyl ether as well as 2,2,2-trifluoroethyl-trifluoromethyl ether in particular, display a low risk for human toxicity. This can be concluded from the available results of mammalian HFC (hydrofluorocarbon) tests. Also, information available on commercial hydrofluoromonoethers gives no evidence of carcinogenicity, mutagenicity, reproductive/developmental effect and other chronic effects of the compounds of the present application. Based on the data available for commercial hydrofluoro ethers of higher molecular weight, it can be concluded that the hydrofluoromonoethers, and in particular pentafluoro-ethyl-methyl ether as well as 2,2,2-trifluoroethyl-trifluoromethyl ether, have a lethal concentration LC 50 of higher than 10'000 ppm, rendering them suitable also from a toxicological point of view.

The mentioned hydrofluoromonoethers have a higher dielectric strength than air. In particular, pentafluoro-ethyl-methyl ether has a dielectric strength about 2.4 times higher than air at 1 bar.

Given its boiling point, which is preferably below 55° C., more preferably below 40° C., in particular below 30° C., the mentioned hydrofluoromonoethers, particularly pentafluoro-ethyl-methyl ether and 2,2,2-trifluoroethyl-trifluoromethyl ether, respectively, are normally in the gaseous state at operational conditions. Thus, inclusions inside which every component is in the gaseous state at operational conditions of the electrical apparatus can be achieved, which is preferred, as mentioned.

Alternatively or additionally to the hydrofluoromonoethers mentioned herein, at least a portion of the inclusions comprises a fluoroketone containing from four to twelve carbon atoms.

The term “fluoroketone” as used in this application shall be interpreted broadly and shall encompass both perfluoroketones and hydrofluoroketones, and shall further encompass both saturated compounds and unsaturated compounds, i.e. compounds including double and/or triple bonds. The at least partially fluorinated alkyl chain of the fluoroketones can be linear or branched. In exemplary embodiments, the fluoroketone is a perfluoroketone. In further exemplary embodiment, the fluoroketone has a branched alkyl chain, in particular an at least partially fluorinated alkyl chain. In still further exemplary embodiments, the fluoroketone is a fully saturated compound.

Compared to fluoroketones having a greater chain length with more than six carbon atoms, fluoroketones containing five or six carbon atoms have the advantage of a relatively low boiling point. Thus, problems which might go along with liquefaction can be avoided even when the electrical apparatus is used at low temperatures.

According to a preferred embodiment, the fluoroketone is at least one compound selected from the group consisting of the compounds defined by the following structural formulae in which at least one hydrogen atom is substituted with a fluorine atom:

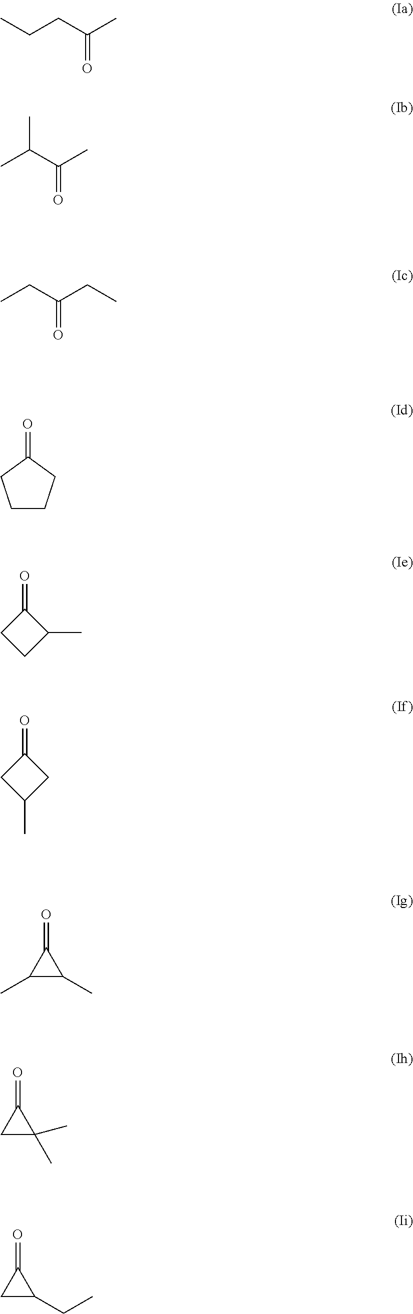

Fluoroketones containing five or more carbon atoms are further advantageous, because they are generally non-toxic with outstanding margins for human safety. This is in contrast to fluoroketones having less than four carbon atoms, such as hexafluoroacetone (or hexafluoropropanone), which are toxic and very reactive. In particular, fluoroketones containing exactly five carbon atoms, herein briefly named fluoroketones a), and fluoroketones containing exactly six carbon atoms are thermally stable up to 500° C.

In embodiments of this invention, the fluoroketones, in particular fluoroketones a), having a branched alkyl chain are advantageous, because their boiling points are lower than the boiling points of the corresponding compounds (i.e. compounds with same molecular formula) having a straight alkyl chain.

According to embodiments, the fluoroketone a) is a perfluoroketone, in particular has the molecular formula C₅F₁₀O, i.e. is fully saturated without double or triple bonds. The fluoroketone a) may more preferably be selected from the group consisting of 1,1,1,3,4,4,4-heptafluoro-3-(trifluoromethyl) butan-2-one (also named decafluoro-2-methylbutan-3-one), 1,1,1,3,3,4,4,5,5,5-decafluoropentan-2-one, 1,1,1,2,2,4,4,5,5,5-decafluoropentan-3-one and octafluorocylcopentanone; and most preferably is 1,1,1,3,4,4,4-heptafluoro-3-(trifluoromethyl) butan-2-one.

1,1,1,3,4,4,4-heptafluoro-3-(trifluoromethyl)butan-2-one can be represented by the following structural formula (I):

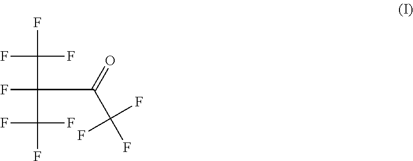 [SMILES: O=C(C(F)(F)F)C(F)(C(F)(F)F)C(F)(F)F]

1,1,1,3,4,4,4-heptafluoro-3-(trifluoromethyl)butan-2-one, here briefly called “C5-ketone”, with molecular formula CF₃C(O) CF (CF₃)₂ or C₅F₁₃O, has been found to be particularly preferred for high and medium voltage insulation applications, because it has the advantages of high dielectric insulation performance, in particular in mixtures with a dielectric carrier gas, has very low GWP and has a low boiling point. It has an ODP of 0 and is practically non-toxic.

According to embodiments, even higher insulation capabilities can be achieved by combining the mixture of different fluoroketone components. In embodiments, a fluoroketone containing exactly five carbon atoms, as described above and here briefly called fluoroketone a), and a fluoroketone containing exactly six carbon atoms or exactly seven carbon atoms, here briefly named fluoroketone c), can favourably be part of the dielectric insulation at the same time.

Thus, an insulation medium can be achieved having more than one fluoroketone, each contributing by itself to the dielectric strength of the inclusion.

In embodiments, the further fluoroketone c) is at least one compound selected from the group consisting of the compounds defined by the following structural formulae in which at least one hydrogen atom is substituted with a fluorine atom:

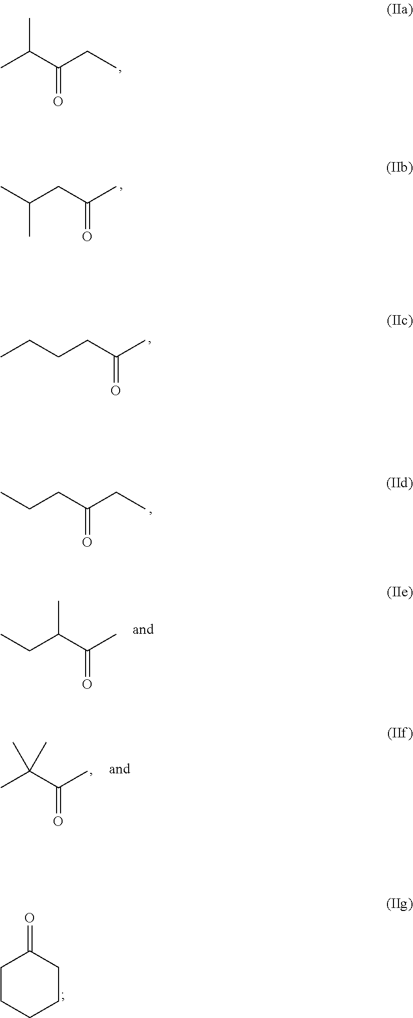

as well as any fluoroketone having exactly 6 carbon atoms, in which the at least partially fluorinated alkyl chain of the fluoroketone forms a ring, which is substituted by one or more alkyl groups (IIh);
and/or is at least one compound selected from the group consisting of the compounds defined by the following structural formulae in which at least one hydrogen atom is substituted with a fluorine atom:

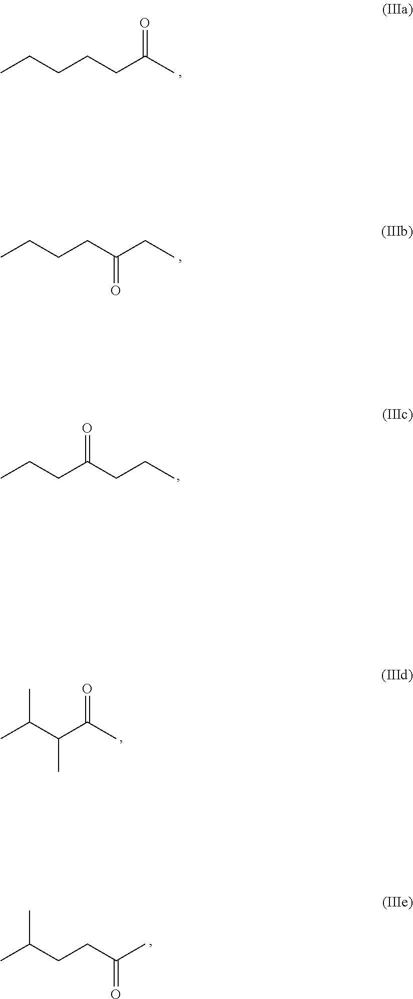

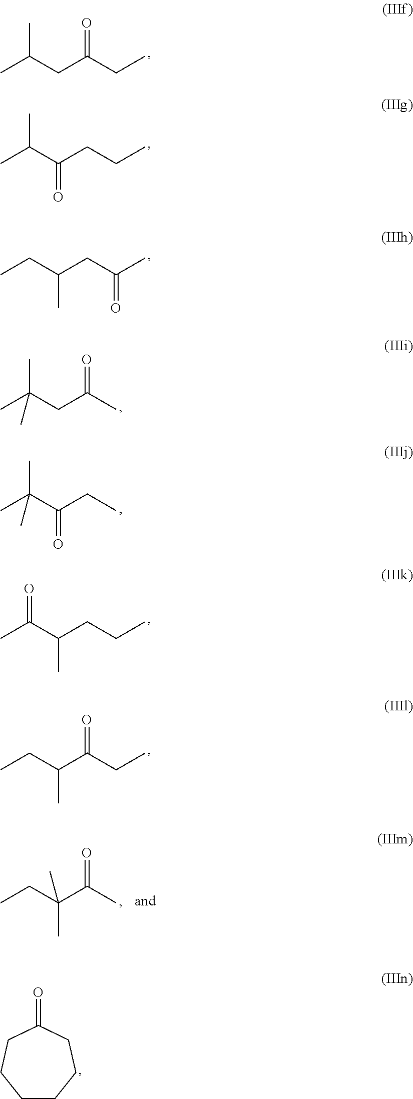

in particular dodecafluoro-cycloheptanone,
as well as any fluoroketone having exactly 7 carbon atoms, in which the at least partially fluorinated alkyl chain of the fluoroketone forms a ring, which is substituted by one or more alkyl groups (IIIo).

The present invention encompasses, in particular, each combination of any of the compounds according to structural formulae Ia to Id with any of the compounds according to structural formulae IIa to IIg and/or IIIa to IIIn. As well, the present invention encompasses each compound or each combination of compounds selected from the group consisting of the compounds according to structural formulae (Ia) to (Ii), (IIa) to (IIh), (IIIa) to (IIIo), and mixtures thereof.

Depending on the specific application of the electrical insulator of the present invention, a fluoroketone containing exactly six carbon atoms (falling under the designation “fluoroketone c)” mentioned above) may be preferred; such a fluoroketone is non-toxic, with outstanding margins for human safety.

In embodiments, fluoroketone c), alike fluoroketon a), is a perfluoroketone, and/or has a branched alkyl chain, in particular an at least partially fluorinated alkyl chain, and/or the fluoroketone c) contains fully saturated compounds.

In particular, the fluoroketone c) has the molecular formula C₆F₁₂O, i.e. is fully saturated without double or triple bonds. More preferably, the fluoroketone c) can be selected from the group consisting of 1,1,1,2,4,4,5,5,5-nonafluoro-2-(trifluoromethyl)pentan-3-one (also named dodecafluoro-2-methylpentan-3-one), 1,1,1,3,3,4,5,5,5-nonafluoro-4-(trifluoromethyl)pentan-2-one (also named dodecafluoro-4-methylpentan-2-one), 1,1,1,3,4,4,5,5,5-nonafluoro-3-(trifluoromethyl)pentan-2-one (also named dodecafluoro-3-methylpentan-2-one), 1,1,1,4,4,4-hexafluoro-3,3-bis-(trifluoromethyl)butan-2-one (also named dodecafluoro-3,3-(dimethyl)butan-2-one), dodecafluorohexan-2-one, dodecafluorohexan-3-one and decafluorocyclohexanone, and particularly is the mentioned 1,1,1,2,4,4,5,5,5-nonafluoro-2-(trifluoromethyl)pentan-3-one.

1,1,1,2,4,4,5,5,5-Nonafluoro-2-(trifluoromethyl)pentan-3-one (also named dodecafluoro-2-methylpentan-3-one) can be represented by the following structural formula (II):

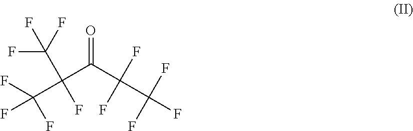 [SMILES: O=C(C(F)(F)C(F)(F)F)C(F)(C(F)(F)F)C(F)(F)F]

1,1,1,2,4,4,5,5,5-Nonafluoro-4-(trifluoromethyl)pentan-3-one (here briefly called “C6-ketone”, with molecular formula C₂F₅C(O) CF (CF₃)₂, has been found to be particularly preferred for high voltage insulation applications because of its high insulating properties and its extremely low GWP. Specifically, its pressure-reduced breakdown field strength E_{cr} is around 240 kV/cm/bar which is much higher than the one of air having a relatively weaker dielectric strength (E_{cr}=25 kV/cm/bar). It has an ozone depletion potential of 0 and is non-toxic (LC50 of about 100'000 ppm). Thus, the environmental impact is very low, and at the same time outstanding margins for human safety are achieved.

As mentioned above, the organofluorine compound can also be a fluoroolefin, in particular a hydrofluoroolefin. More particularly, the fluoroolefin or hydrofluorolefin, respectively, contains exactly three carbon atoms.

According to a particularly preferred embodiment, the hydrofluoroolefin is thus selected from the group consisting of: 1,1,1,2-tetrafluoropropene (HFO-1234yf), 1,2,3,3-tetrafluoro-2-propene (HFO-1234yc), 1,1,3,3-tetrafluoro-2-propene (HFO-1234zc), 1,1,1,3-tetrafluoro-2-propene (HFO-1234ze), 1,1,2,3-tetrafluoro-2-propene (HFO-1234ye), 1,1,1,2,3-pentafluoropropene (HFO-1225ye), 1,1,2,3,3-pentafluoropropene (HFO-1225yc), 1,1,1,3,3-pentafluoropropene (HFO-1225zc), (Z)1,1,1,3-tetrafluoropropene (HFO-1234zeZ), (Z)1,1,2,3-tetrafluoro-2-propene (HFO-1234yeZ), (E)1,1,1,3-tetrafluoropropene (HFO-1234zeE), (E)1,1,2,3-tetrafluoro-2-propene (HFO-1234yeE), (Z)1,1,1,2,3-pentafluoropropene (HFO-1225yeZ), (E)1,1,1,2,3-pentafluoropropene (HFO-1225yeE) and combinations thereof.

According to a further aspect, the present invention further relates to a method for preparing an electrical insulator in particular as described above, said method comprising the step of processing a prepolymeric or polymeric mass before its solidification to the electrical insulating, solid material, whereby the processing is performed in the presence of at least one organofluorine compound having a lower Global Warming Potential (GWP) than SF₆.

The term “processing a prepolymeric or polymeric mass before its solidification” is to be understood broadly and, in particular, shall encompass the processing of a thermosetting prepolymeric mass, more particularly the curing of a reaction resin to the polymeric material, as well as the processing of a thermoplastic polymeric material in melted form. The term “performed in the presence of at least one organofluorine compound” is also to be understood broadly and in particular encompasses embodiments in which the at least one organoflourine compound is only temporarily present during the processing of the prepolymeric or polymeric mass, and, thus, not necessarily during the entire processing.

Specifically, the method of the present invention includes the step of processing the prepolymeric or polymeric mass in the presence of a cover gas comprising or at least essentially consisting of the at least one organofluorine compound.

The term “prepolymeric mass” thereby includes both a mass comprising the precursor resin without further components as well as the reaction resin comprising the precursor resin and further components, particularly a hardener.

The term “cover gas” as used in the context of the present invention shall be interpreted broadly as a gas which is in contact with the mass during its processing and which at least partially shields the mass from coming into contact with other gases.

In order to achieve an optimum insulating performance, the partial pressure of the cover gas is typically chosen as high as possible in order to achieve a particularly high resistance of the electrical insulator to dielectric breakdown. Typically, the processing of the mass comprises casting it into a desired shape, preferably by injection molding.

Casting of a thermosetting prepolymeric mass by injection molding according to the present invention generally includes the steps or method elements of:
a) Separately providing the components of the prepolymeric mass,
b) Preheating a mold,
c) Charging the mold with a cover gas containing the at least one organofluorine compound,
d) Preparing the prepolymeric mass, i.e. the reaction resin, by mixing its components,
e) Injecting the prepolymeric mass into the mold while simultaneously at least partially removing the cover gas, and
f) Curing the prepolymeric mass with the hardener to the solid, electrical insulating polymeric material.

The components of step a) can, for example, include, apart from the precursor resin, a hardener, a flexibilizer, an accelerator, a filler and/or a dye. Step a) can, for example, include separate pre-drying of at least the precursor resin and the hardener in a vacuum pre-mixer.

In embodiments, the casting of the prepolymeric mass by injection molding comprises the method elements of: (i) forming voids, which comprise the organofluorine compound, in the prepolymeric mass during any of the steps d) to f), and (ii) stabilizing the voids during Curing (possibly including post-curing), in particular during the Curing in step f), such that an amount of the organofluorine compound is comprised in the voids and forms inclusions of the electrical insulator.

If a filler is included, it is also preferably pre-dried before being introduced. Any filler known to the skilled person as suitable for the respective purpose can be used. Particularly, the filler is selected from the group consisting of metal oxides, SiO₂, Al₂O₃ or ATH (Aluminum Trihydroxide), carbonates, mica, talc, clays, glass fibers, and mixtures thereof.

According to a specific embodiment, the precursor resin is an epoxy resin.

Optionally, the cavity of the mold can comprise at least one component, more particularly an electrical component, to be integrally casted. Preheating of the mold—optionally comprising the (electrical) component—according to step b) can, for example, be carried out at a temperature ranging from about 60° C. to about 110° C.

After step b) and prior to step c), the process can further comprise the optional step of at least partially evacuating the cavity of the mold. Evacuation can, for example, be performed down to a pressure of less than about 30 mbar, preferably in the range of about 0.1 mbar to about 3 mbar.

After step f), the method can further comprise the optional step of post-curing the polymeric material, for example at a temperature selected in a range from 120° C. to 160° C. and in particular at a temperature of about 140° C.

In particular, the method of the present invention can also encompass automatic pressure gelation processes.

The method of the present invention can also encompass embodiments, in which a strand or foil with the prepolymeric or polymeric mass applied thereon is wound. The concept of the present invention is particularly useful for these embodiments, since these embodiments are particularly prone to the formation of voids, especially at the interface between two radial layers and/or between alternating material components.

For example, the present invention relates to a method in which a foil conductor with the prepolmyeric or polymeric mass applied thereon is wound in a radial direction, one on top of the other, to result in a disc winding in which a layer of insulating material is disposed between each layer or turn of the conductor. In this particular embodiment, the insulating material may be comprised of a polyimide film, such as is sold under the trademark Nomex®; a polyamide film, such as is sold under the trademark Kapton®; or a polyester film, such as is sold under the trademark Mylar®.

The organofluorine compound used for the method of the present invention can correspond to the ones mentioned above for the electrical insulator.

Since according to this method the bubbles that are typically formed during processing of the prepolymeric or polymeric mass comprise the organofluorine compound, an electrical insulator as described above with the above described features and advantages is thereby formed in a very straightforward manner.

Since electrical insulators used in medium and high voltage applications are particularly prone to partial discharge phenomena, the present invention further relates—according to a further aspect—the use of the electrical insulator in a high-voltage or medium-voltage electrical apparatus, as thereby the advantages of the present invention are of particular relevance.

More particularly, the present invention relates to the use of the electrical insulator in an insulating spacer, a post type spacer, a cast insulating cylinder, in particular an insulating cylinder for a condenser, an insulating envelope, a partition insulator or base insulator, an insulating rod, an insulating shaft e.g. for movement transmission in a gas-insulated switchgear (GIS), a bushing, an insulating joint, an insulating terminal, a cable insulation, and/or an insulating coating, in particular an insulating coating of an inner conductor. Apart from a GIS, further fields of applications of the electrical insulator according to the present invention include its use in a voltage transformer, a current transformer, a cable distribution head and a ground electrode, for example.

In analogy, the present invention thus also relates to an electrical insulator as described above, said insulator forming or being part of: an insulating spacer, a post type spacer, a partition insulator or base insulator, a support insulator, a suspended insulator, a bushing, a high voltage insulator, a medium voltage insulator, a low voltage insulator, a cast insulating cylinder, an insulating envelope, an insulating rod, an insulating shaft, an insulating joint, an insulating terminal, a cable insulation, and/or an insulating coating.

According to a further aspect, the present invention also relates to an apparatus for the generation, the distribution and/or the usage of electrical energy, said apparatus comprising an electrical insulator as described herein.

In embodiments, the apparatus is part of or is a: high voltage apparatus, medium voltage apparatus, low voltage apparatus, direct-current apparatus, switchgear, air-insulated switchgear, part or component of air-insulated switchgear, gas-insulated metal-encapsulated switchgear (GIS), part or component of gas-insulated metal-encapsulated switchgear, air-insulated transmission line, gas-insulated transmission line (GIL), bus bar, bushing, air-insulated insulator, gas-insulated metal-encapsulated insulator, cable, gas-insulated cable, cable joint, current transformer, voltage transformer, sensors, surge arrester, capacitor, inductance, resistor, current limiter, high voltage switch, earthing switch, disconnector, load-break switch, circuit breaker, gas circuit breaker, vacuum circuit breaker, generator circuit breaker, medium voltage switch, ring main unit, recloser, sectionalizer, low voltage switch, transformer, distribution transformer, power transformer, tap changer, transformer bushing, electrical rotating machine, generator, motor, drive, semiconducting device, power semiconductor device, power converter, computing machine; and components and/or combinations of such devices.

According to a still further aspect, the present invention further relates to the use of an organofluorine compound as a cover gas in the processing of a prepolymeric or polymeric mass, in particular for providing an electrical insulating, solid material for an electrical insulator, as mentioned herein.

### BRIEF DESCRIPTION OF THE DRAWINGS

The present invention is further illustrated by way of the following figures, of which

FIG. 1 shows purely schematically a cross-sectional view of an electrical insulator according to the present invention arranged between two electrodes;

FIG. 2 shows the layout of a facility for producing an electrical insulator according to the present invention by injection molding;

FIG. 3 shows purely schematically a cross-sectional view of a mold to be used for the production of an electrical insulator according to the present invention by injection molding, together with an electrical component to be integrally cast;

FIG. 4 shows purely schematically an electrical insulator according to the present invention obtainable by an injection molding process using the mold according to FIG. 3;

FIG. 5a shows a photograph of an electrical insulator for insulating the space between two electrodes;

FIG. 5b shows a drawing of the electrical insulator of the photograph according to FIG. 5a; and

FIG. 6 shows an X-ray photograph of another electrical insulator produced according to the present invention.

### DETAILED DESCRIPTION OF THE INVENTION

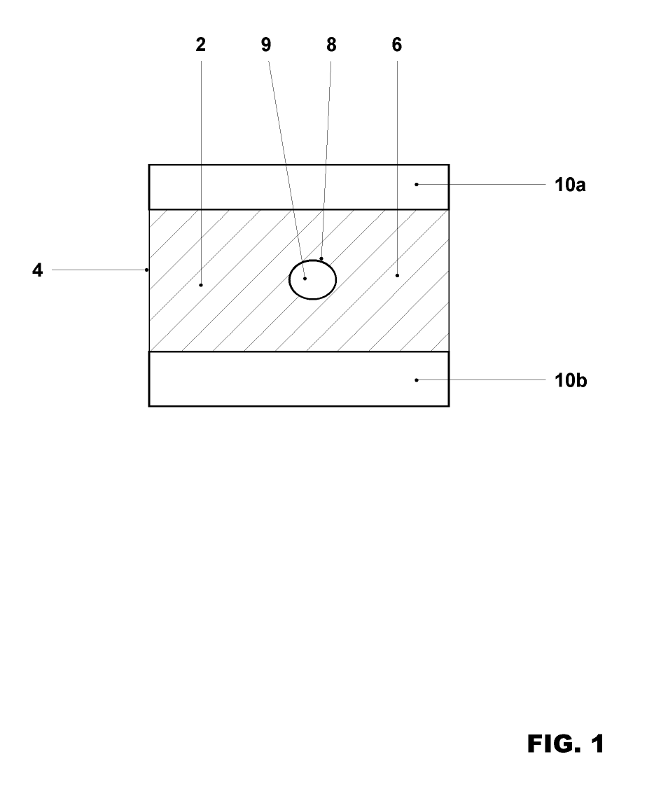

The electrical insulator 2 shown in FIG. 1 is sandwiched between two electrodes 10a, 10b and comprises a body 4 containing an electrical insulating, solid material 6 and non-solid inclusions 8 dispersed within the body 4. In FIG. 1, only one of these inclusions 8 is shown for reasons of illustration. The inclusion 8 defines an inclusion space 9 and comprises inside at least one organofluorine compound having a lower Global Warming Potential than SF₆. In embodiments, the inclusions in the electrical insulator have a Global Warming Potential (GWP over 100 years) of less than 22'800, preferably less than 15'000, more preferably less than 10'000, even more preferably less than 5'000, even more preferably less than 3'000, even more preferably less than 2'000, even more preferably less than 1'000, even more preferably less than 700, even more preferably less than 300, even more preferably less than 100, even more preferably less than 50, even more preferably less than 20, most preferred less than 10.

Due to the presence of the organofluorine compound, a very high dielectric strength within the inclusion space 9 is achieved; the tendency of the electrical insulator 2 for partial discharge is thus significantly reduced.

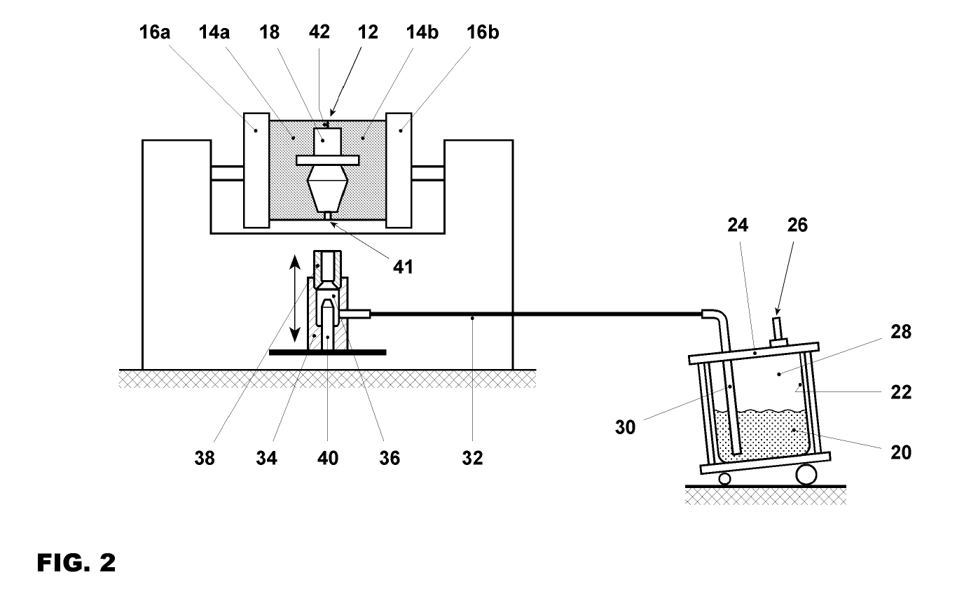

The electrical insulator 2 can e.g. be prepared by injection molding, a layout of a corresponding facility being shown in FIG. 2. The facility in FIG. 2 includes a mold 12 comprising two mold parts 14a, 14b each being connected to a platen 16a, 16b and moveable with respect to each other. In the clamped position shown in FIG. 2, the mold parts 14a, 14b define a mold cavity 18.

The prepolymeric or polymeric mass 20 to be molded is stored in a pressure vessel 22, the wall 24 of which being provided with a fitting 26 to be connected to a gas inlet pipe (not shown) for charging a cover gas comprising an organofluorine compound and thereby pressurizing the interior 28 of the pressure vessel 22.

Upon pressurization, the mass 20 is pumped through an ascending pipe 30 into a pressure pipe 32 which opens out into the interior 36 of a barrel 34. Said barrel 34 comprises a nozzle 38 which is connectable to the mold 12 and through which the mass 20 can be forced by means of a piston 40 via an injection channel 41 into the mold cavity 18.

Like the pressure vessel 22, the mold cavity 18 is charged with a cover gas comprising an organofluorine compound. To this end, the mold 12 comprises a ventilation channel 42 which is connected to a respective gas inlet pipe (not shown). Both the gas inlet pipe connected to the fitting 26 of the pressure vessel 22 as well as the gas inlet pipe connected to the ventilation channel 42 of the mold 12 are fed by a pressure tank (not shown) filled with the cover gas comprising the organofluorine compound.

The mold 12 can further be connected to an evacuation pump for evacuating the mold cavity 18 prior to the charging with the cover gas (not shown).

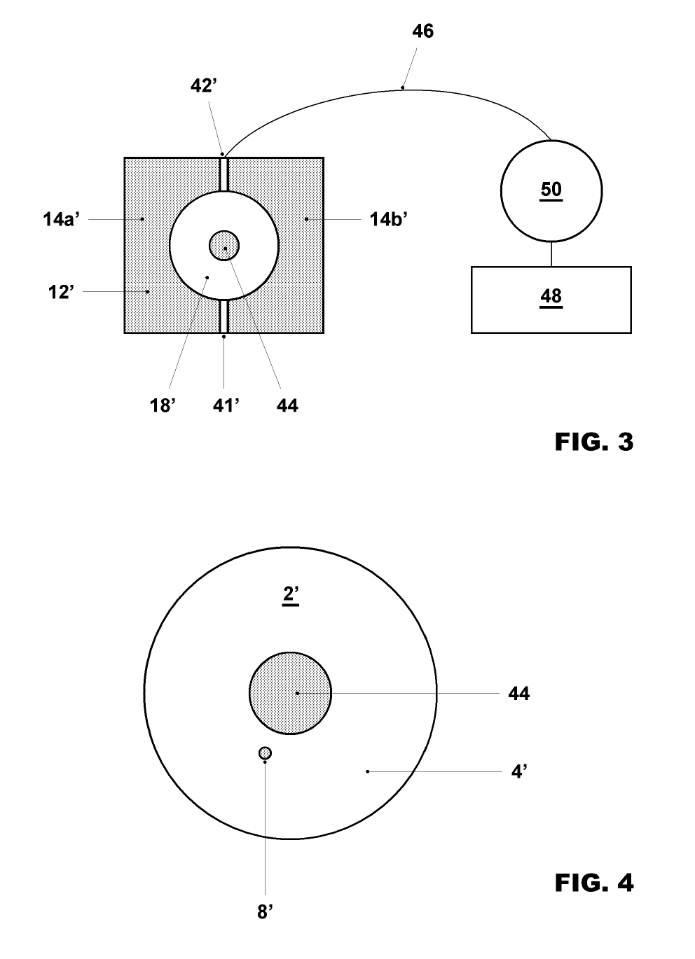

FIG. 3 relates to the integral casting of an electrical component 44 and specifically shows a mold 12′ comprising two mold parts 14a′, 14b′ defining a mold cavity 18′ having a circular cross-section with the electrical component 44 being arranged in the centre of the mold cavity 18′. The mold 12′ further comprises an injection channel 41′ opening into the mold cavity 18′ and a ventilation channel 42′. The ventilation channel 42′ is connected to a gas inlet pipe 46 which itself is fed with cover gas comprising an organofluorine compound (as disclosed herein) from a cover-gas-containing tank 48 by means of a pump 50.

The electrical insulator 2′ obtainable by an injection molding process using the mold 12′ shown in FIG. 3 is given in FIG. 4. In the injection molding process, voids or bubbles are formed spontaneously within the prepolymeric mass resulting in the inclusions 8′ present within the body 4′ of the electrical insulator 2′. As the cover gas used for the processing comprises an organofluorine compound, also the inclusions 8′ comprises the organofluorine compound. Thus, the tendency of the electrical insulator 2′ for partial discharge is significantly reduced which results in a much safer operation of the electrical apparatus in which the electrical insulator 2′ is used.

Throughout this application, terms like “preferable”, “preferred”, “advantageous”, “favourable” and the like shall designate embodiments or exemplary features only, that are thus disclosed to be optional only.

The disclosed electrical insulator and its corresponding method for preparing or producing the electrical insulator encompass any production method or production device in which the cover gas containing an organofluorine compound is present and can be incorporated into the thus prepared insulator. For example, it encompasses any preparing method which includes casting, wet winding, UV-cured casting, injection molding, or extrusion, e.g. of thermoplasts, or similar processes.

### Examples

In order to proof the concept of the invention, two autoclaves were provided, which were connected to a vacuum oven (Heraeus Vacutherm, Type VT6130 M) preheated at 80° C. and comprising a mold 12.

Into a first autoclave, “C5-ketone” 1,1,1,3,4,4,4-heptafluoro-3-(trifluoromethyl)butan-2-one was filled up to 800 mbar and then topped with N₂ up to a total pressure of 3 bar. The gas mixture was mixed with a mechanical propeller arranged in the autoclave.

In the second autoclave, a prepolymeric mass containing a 100:80 mixture of bisphenol A diglycidyl ether (Araldit® CY225 from Huntsman) and a hardener (Aradur® HY 225 from Huntsman) was provided.

The vacuum oven was evacuated, then the connection with the first autoclave was opened letting the gas flow into the oven and equilibrate, such that a final pressure of 1 bar was achieved.

Thereupon, the connection with the second autoclave was opened and the prepolymeric mass was transferred into the mold until the casting was completed.

The oven temperature was then set to 100° C. and, after 30 minutes, the temperature was raised to 130° C. in order to cure the mass. After 6 hours of curing, a cured body for use in an electrical insulator 2 was obtained.

The body 4 of the thus produced electrical insulator 2 contains inclusions 8 dispersed within the body 4, said inclusions 8 comprising 1,1,1,3,4,4,4-heptafluoro-3-(trifluoromethyl)butan-2-one and N₂.

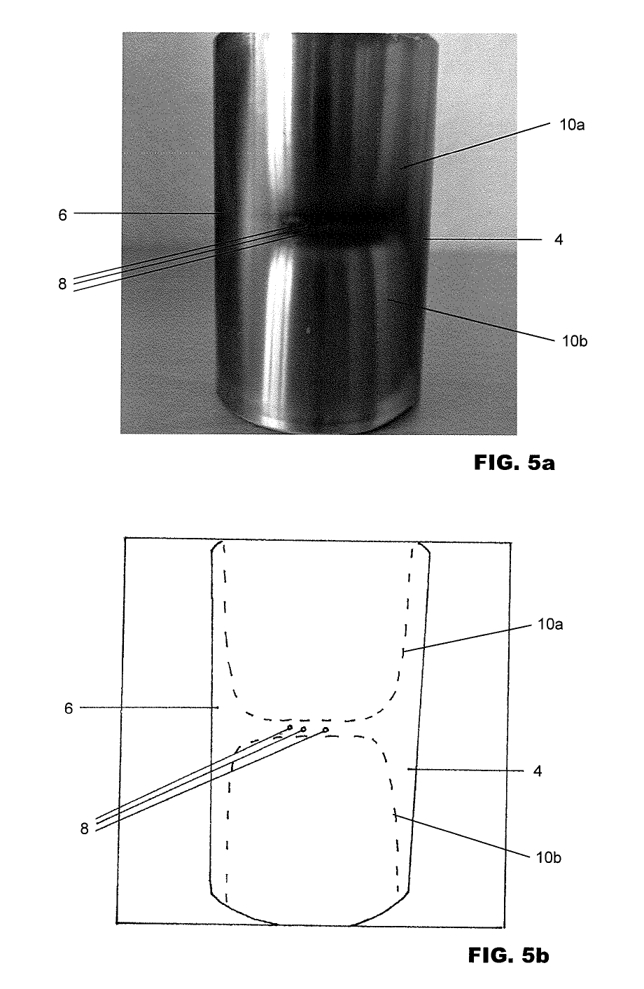

Such a body 4 formed according to the process of the present invention is shown in she above-mentioned FIGS. 5a, 5b and

FIG. 5a relates to a photograph of the electrical insulator 2 for insulating the space between two rods or rod-like electrodes 10a, 10b wherein said insulator 2 prepared according to the above-disclosed execution example.

FIG. 5b relates to a corresponding schematic drawing of the electrical insulator 2 shown by the photograph of FIG. 5a.

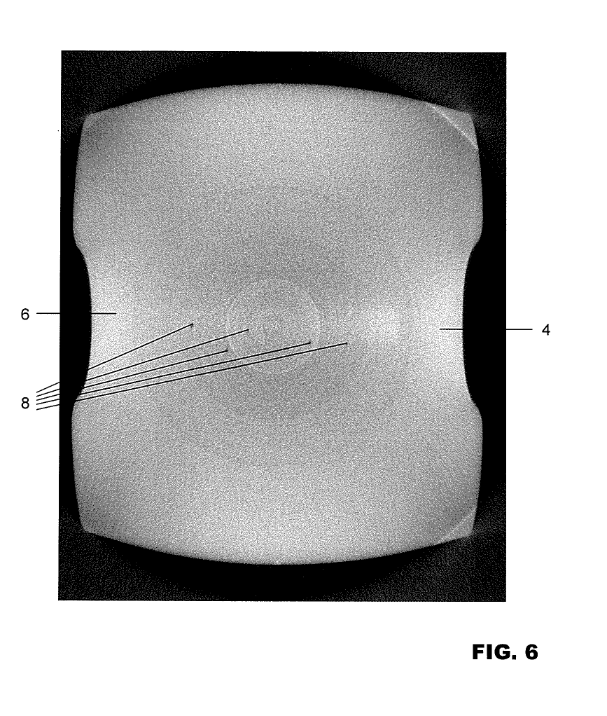

FIG. 6 relates to an X-ray photograph of another electrical insulator 2 according to the present invention which is also based on cast epoxy polymer, and particular which is also produced according to the production method disclosed herein.

As is clearly visible in FIGS. 5a and 5b, the body of the electrical insulator 2 contains the electrical insulating, solid material 6, in the specific case an epoxy polymer, and non-solid inclusions 8 dispersed within the body 4, in the specific case inclusions containing the cover gas mixture of 1,1,1,3,4,4,4-heptafluoro-3-(trifluoromethyl)butan-2-one (C5-fluoroketone) and nitrogen gas N₂.

Such inclusions 8 are likewise shown in FIG. 6. Particularly, five inclusions 8 are shown and have diameters between 0.5 mm and 1.2 mm. Again, the inclusions 8 were formed under application of the cover gas mixture of 1,1,1,3,4,4,4-heptafluoro-3-(trifluoromethyl)butan-2-one (C5-fluoroketone) and nitrogen gas N₂ and likewise contain such a gas mixture.

Compared to conventional electrical insulators comprising air inclusions, the electrical insulator 2, 2′ according to the present disclosure show a reduced or strongly reduced tendency for partial discharge, which ultimately results in a very safe operation of any electrical apparatus comprising such an electric insulator 2, 2′.

### LIST OF REFERENCE NUMERALS

2, 2′ electrical insulator
4, 4′ body of the electrical insulator
6 electrical insulating, solid material
8, 8′ non-solid inclusion
9 inclusion space
10a, 10b electrodes
12, 12′ mold
14a, 14b, 14a′, 14b′ mold parts
16a, 16b platen
18, 18′ mold cavity
20 prepolymeric or polymeric mass to be molded
22 pressure vessel
24 wall of the pressure vessel
26 fitting
28 interior of the pressure vessel
30 ascending pipe
32 pressure pipe
34 barrel
36 interior of the barrel
38 nozzle
40 piston
41, 41′ injection channel
42, 42′ ventilation channel
44 electrical component
46 gas inlet pipe
48 cover-gas-containing tank
50 pump

1. An electrical insulator for an electrical apparatus, said insulator comprising a body containing an electrical insulating, solid polymeric material and non-solid inclusions dispersed within the body, wherein at least a portion of the inclusions comprise at least one organofluorine compound having a lower Global Warming Potential than SF₆, characterized in that the inclusions are in the form of bubbles spontaneously formed during processing of the polymeric or prepolymeric mass on which the polymeric material is based, in that the body has a density higher than 150 kg/m³ and in that the at least one organofluorine compound is selected from the group consisting of: fluoroethers, fluoroketones, fluoroolefins, and mixtures thereof, and the inclusions having a Global Warming Potential of less than 3'000.

2. The electrical insulator according to claim 1, characterized in that the at least one organofluorine compound is selected from the group consisting of: hydrofluoromonoethers, hydrofluoroolefins, and mixtures thereof.

3. The electrical insulator according claim 1, characterized in that at least a portion of the inclusions comprises a hydrofluoromonoether containing at least three carbon atoms.

4. The electrical insulator according to claim 1, characterized in that at least a portion of the inclusions comprises a fluoroketone containing from four to twelve carbon atoms.

5. The electrical insulator according to claim 4, characterized in that the fluoroketone contains exactly five or exactly six carbon atoms.

6. The electrical insulator according to claim 1, characterized in that the at least one organofluorine compound is in the gaseous state at operational conditions of the electrical apparatus.

7. The electrical insulator according to claim 1, characterized in that every component of the inclusions is in the gaseous state at operational conditions of the electrical apparatus.

8. The electrical insulator according to claim 7, characterized in that the polymeric material is selected from the group consisting of: silicones, acrylic resins, polystyrenes, polyurethanes, polyimides, polyamides, polyesters, polyolefins, polyethers, polyketones, polysulfones and epoxy polymers, as well as mixtures thereof; and in particular is selected from the group consisting of: silicones, acrylic resins, polystyrenes, polyurethanes, polyesters and epoxy polymers, as well as mixtures thereof.

9. The electrical insulator according to claim 1, characterized in that at least some of the inclusions each define a separate bubble, the size of which being in the submillimeter scale, specifically in the microscopic scale.

10. The electrical insulator according to claim 9, characterized in that the bubble has an average diameter in the range from 10 μm to 500 μm.

11. The electrical according to claim 1, characterized in that at least some of the inclusions formed in the interior of hollow bodies, in particular in the interior of hollow microspheres, that are present in the electrical insulating solid material.

12. The electrical insulator according to claim 1, characterized in that the body has a density higher than 170 kg/m³.

13. The electrical insulator according to claim 1, characterized in that the body comprises a filler, in particular a filler selected from the group consisting of: metal oxides, SiO₂, Al₂O₃, carbonates, mica, talc, clays, glass fibers, and mixtures thereof.

14. The electrical insulator according to claim 1, said insulator forming or being part of a: insulating spacer, post type spacer, partition insulator or base insulator, support insulator, suspended insulator, bushing, high voltage insulator, medium voltage insulator, low voltage insulator, cast insulating cylinder, insulating envelope, insulating rod, insulating shaft, insulating joint, insulating terminal, cable insulation, and/or insulating coating.

15. The electrical insulator according to claim 1, characterized in that the inclusions in the electrical insulator have a Global Warming Potential of less than 2'000.

16. The electrical insulator according to claim 1, characterized in that the inclusions have a dielectric strength higher than that of air; and/or that the organofluorine compound has a dielectric strength higher than that of air.

17. The electrical insulator according to claim 1, characterized in that the inclusions comprise at least one component selected from the group consisting of: air, air component, carbon dioxide, oxygen, nitrogen, noble gas, nitric oxide, nitrogen dioxide, and mixtures thereof.

18. The electrical insulator according to claim 1, characterized in that the organofluorine compound has a global warming potential GWP over 100 years of less than 1000.

19. An apparatus for the generation, the distribution and/or the usage of electrical energy, said apparatus comprising an electrical insulator according to claim 1.

20. The apparatus according to claim 19, said apparatus being a part of or being a: high voltage apparatus, medium voltage apparatus, low voltage apparatus, direct-current apparatus, switchgear, air-insulated switchgear, part or component of air-insulated switchgear, gas-insulated metal-encapsulated switchgear (GIS), part or component of gas-insulated metal-encapsulated switchgear, air-insulated transmission line, gas-insulated transmission line (GIL), bus bar, bushing, air-insulated insulator, gas-insulated metal-encapsulated insulator, cable, gas-insulated cable, cable joint, current transformer, voltage transformer, sensors, surge arrester, capacitor, inductance, resistor, current limiter, high voltage switch, earthing switch, disconnector, load-break switch, circuit breaker, gas circuit breaker, vacuum circuit breaker, generator circuit breaker, medium voltage switch, ring main unit, recloser, sectionalizer, low voltage switch, transformer, distribution transformer, power transformer, tap changer, transformer bushing, electrical rotating machine, generator, motor, drive, semiconducting device, power semiconductor device, power converter, computing machine; and components and/or combinations of such devices.

21. A method for preparing an electrical insulator, in particular for preparing an electrical insulator according to claim 1, said method comprising the step of processing a prepolymeric or polymeric mass before its solidification to an electrical insulating solid material, characterized in that the processing of the prepolymeric or polymeric mass comprises casting it into a desired shape and is performed in the presence of at least one organofluorine compound having a lower Global Warming Potential than SF₆, and in that the at least one organofluorine compound is selected from the group consisting of: fluoroethers, fluoroketones, fluoroolefins, and mixtures thereof.

22. The method according to claim 21, characterized in that the processing is performed in the presence of a cover gas comprising the at least one organofluorine compound.

23. The method according to any of the claims 21 to 22, wherein the processing of the prepolymeric or polymeric mass relates to the processing of a thermosetting prepolymeric mass, more particularly the curing of a reaction resin to the polymeric material, and/or to the processing of a thermoplastic polymeric material in melted form.

24. The method according to any of the claims 21 to 22, characterized in that casting is performed by injection molding.

25. The method according to claim 24, characterized in that casting of the prepolymeric mass by injection molding comprises the steps of:
a) Separately providing the components of the prepolymeric mass,
b) Preheating a mold,
c) Charging the mold with a cover gas containing the at least one organofluorine compound,
d) Preparing the prepolymeric mass by mixing its components,
e) Injecting the prepolymeric mass into the mold while simultaneously at least partially removing the cover gas, and
f) Curing the prepolymeric mass to produce the solid electrical insulating polymeric material.

26. The method according to any of the claims 21 to 22, characterized in that the processing of the prepolymeric or polymeric mass comprises the method elements of: (i) forming voids, which comprise the organofluorine compound, in the prepolymeric or polymeric mass, and (ii) stabilizing the voids such that an amount of the organofluorine compound is comprised in the voids and forms inclusions of the electrical insulator.

27. The method according to claim 26, characterized in that the casting of the prepolymeric mass by injection molding comprises the method elements of: (i) forming voids, which comprise the organofluorine compound, in the prepolymeric mass during any of the steps d) to f), and (ii) stabilizing the voids during Curing, in particular the Curing in step f), such that an amount of the organofluorine compound is comprised in the voids and forms inclusions of the electrical insulator.

28. The method according to any of the claims 21 to 22, characterized in that the at least one organofluorine compound is selected from the group consisting of: hydrofluoromonoethers, hydrofluoroolefins, and mixtures thereof.

29. The method according to any of the claims 21 to 22, characterized in that the at least one organofluorine compound is a hydrofluoromonoether containing at least three carbon atoms.

30. The method according to any of claims 21 to 22, characterized in that the at least one organofluorine compound is a fluoroketone containing from four to twelve carbon atoms.

31. The method according to claim 30, characterized in that the fluoroketone contains exactly five or exactly six carbon atoms.

32. The method according to any of the claims 21-22, characterized in that casting is performed by injection molding, characterized in that casting of the prepolymeric mass by injection molding comprises the steps of:
a) Separately providing the components of the prepolymeric mass,
b) Preheating a mold,
c) Charging the mold with a cover gas containing the at least one organofluorine compound,
d) Preparing the prepolymeric mass by mixing its components,
e) Injecting the prepolymeric mass into the mold while simultaneously at least partially removing the cover gas, and
f) Curing the prepolymeric mass to produce the solid electrical insulating polymeric material,
characterized by a step of evacuating the mold being executed after step b) and prior to step c), in particular evacuating down to a pressure of less than 30 mbar or down to a pressure range of 0.1 mbar to 3 mbar.

33. The method according to any of the claims 21-22, characterized in that casting is performed by injection molding, characterized in that casting of the prepolymeric mass by injection molding comprises the steps of:
a) Separately providing the components of the prepolymeric mass,
b) Preheating a mold,
c) Charging the mold with a cover gas containing the at least one organofluorine compound,
d) Preparing the prepolymeric mass by mixing its components,
e) Injecting the prepolymeric mass into mold while simultaneously at least partially removing the cover gas, and
f) Curing the prepolymeric mass to produce solid electrical insulating polymeric material,
characterized by a step of post-curing the polymeric material, in particular at a temperature selected in a range from 120° C. to 160° C., being executed after step f).

34. The method according to any of the claims 21 to 22, characterized in that the inclusions in the electrical insulator have a Global Warming Potential of less than 2'000.

35. Use of the electrical insulator according to claim 1 including the step of providing electrical insulation with the electrical insulator in a high-voltage or medium-voltage electrical apparatus.

36. The use according to claim 35, wherein the electrical insulator is in an insulating spacer, a post type spacer, a partition insulator or base insulator, a support insulator, a suspended insulator, a bushing, a high voltage insulator, a medium voltage insulator, a cast insulating cylinder, an insulating envelope, an insulating rod, an insulating shaft, an insulating joint, an insulating terminal, a cable insulation, and/or an insulating coating.

37. Use of an organofluorine compound, including the step of using the organofluorine compound as a cover gas in the processing of a prepolymeric or polymeric mass, in particular for providing an electrical insulating solid material for an electrical insulator and more particularly for an electrical insulator according to claim 1.

38. The electric insulator according to claim 10, characterized in that the bubble has an average diameter in the range from 50 μm to 300 μm.

39. The electric insulator according to claim 10, characterized in that the bubble has an average diameter in the range from 100 μm to 200 μm.

40. The electric insulator according to claim 12, characterized in that the body has a density higher than 220 kg/m³.

41. The electrical insulator according to claim 15, characterized in that the Global Warming Potential is less than 300.

42. The electrical insulator according to claim 15, characterized in that the Global Warming Potential is less than 100.

43. The electrical insulator according to claim 15, characterized in that the Global Warming Potential is less than 50.

44. The electrical insulator according to claim 15, characterized in that the Global Warming Potential is less than 10.

45. The electrical insulator according to claim 18, characterized in that the global warming potential GWP over 100 years is less than 300.

46. The electrical insulator according to claim 18, characterized in that the global warming potential GWP over 100 years is less than 50.

47. The electrical insulator according to claim 18, characterized in that the global warming potential GWP over 100 years is less than 10.

48. The method according to any of the claim 21, characterized in that the inclusions in the electrical insulator have a Global Warming Potential of less than 300.

49. The method according to any of the claim 21, characterized in that the inclusions in the electrical insulator have a Global Warming Potential of less than 50.
